(19) United States
(12) Patent Application Publication
(10) Pub. No.: US 2019/0107211 A1
(43) Pub. Date: Apr. 11, 2019

(54) BALL VALVE SEAT WITH TRIPLE SEAL

(71) Applicant: GUIDE VALVE LIMITED, Woodbridge (CA)

(72) Inventor: CHARLES LO CICERO, Woodbridge (CA)

(21) Appl. No.: 16/087,095

(22) PCT Filed: Mar. 22, 2016
(86) PCT No.: PCT/CA2016/050327

§ 371 Date: Sep. 21, 2018

(51) Int. Cl. F16K 5/06; F16K 5/20; F16K 25/00; F16K 25/04

(52) U.S. Cl. CPC F16K 5/0673; F16K 25/04; F16K 25/005; F16K 5/20

(57) ABSTRACT

The present invention pertains to a seat for a ball valve, the seat defining an axial bore along an inside surface of the seat. The seat inside surface is in contact with a fluid. At one end of the seat inside surface, the seat comprises a contact portion for contacting a ball. The contact portion comprises a metal-to-metal sealing surface, a thermoplastic seal and an elastomeric seal. The metal-to-metal sealing surface is disposed proximally to the inside surface, the elastomeric seal is disposed distally to the inside surface, and the thermoplastic seal is disposed therebetween, wherein the metal-to-metal sealing surface seals against the ball valve to seal fluid away from the thermoplastic and elastomeric seals.

### CONTINUITY INFORMATION

This application is a 371 national stage filing of PCT CA/2016/050327, filed Mar. 22, 2016. The present application claims priority to the PCT Application.

### BACKGROUND

Seats for ball valves are well known in the prior art. Balls and seats are composed of specific materials, the type of which depends on several factors, including temperature, pressure and type of fluid flowing through the ball valves. For example, a fluid containing a large amount of particulate matter would require ball and seat materials that are resistant to abrasion.

It is also known to include additional sealing elements within seats to improve shut-off of the valve and to prevent leakage. Common sealing elements include thermoplastic seals and elastomeric seals. The choice of sealing element depends on factors such as the temperature, type of fluid and the amount of pressure.

Elastomeric seals are superior to thermoplastic seals for a number of reasons. For example, elastomeric seals are easier to compress, thus requiring a much lower working pressure for sealing as compared to thermoplastic materials such as resins (i.e. less force is required to push the seat against the ball). In addition, elastomeric seals are cheaper to manufacture. Since thermoplastic seals resist compression, they require precise spherical profiles, geometry and ball surface finishes to effect a robust seal. This required precision leads to higher production costs.

Another advantage of elastomeric seals is their ability to form a seal, even when there is a small amount of damage to either the elastomeric seal or the ball surface (i.e. scratches or grooves causes by abrasion for example). Elastomeric materials can “fill in” the grooves and scratches whereas the performance of the more rigid thermoplastic seals decreases when there is even a small amount of damage to the thermoplastic seal or the ball surface.

A major problem with prior art elastomeric seals, however, is that they are susceptible to damage. For example, as fluid enters a partially open valve, the high pressure causes extrusion of elastomeric seals. Extrusion becomes more problematic under high pressure working conditions. In addition, elastomeric seals are susceptible to damage from abrasion by particulate matter that may be present in some fluids.

On the other hand, thermoplastic seals exhibit several advantages over elastomeric seals. Thermoplastic seals resist corrosion, and are inert with respect to many types of fluids, and therefore useful for a wide range of applications. Another advantage of thermoplastic seals over elastomeric seals is that thermoplastic materials are virtually impermeable to gas, therefore the use of thermoplastic seals reduces the risk of an explosive decompression of the valve if rapid decompression occurs.

Thermoplastic seals are also more resistant to compression, and thus are useful in applications where metal-to-metal contact between a ball and a seat is undesirable. Furthermore, thermoplastic seals resist wear and abrasion to a higher degree than elastomeric seals.

It is also known to manufacture ball valve assemblies with metal sealing elements. Metal-to-metal seats are manufactured for applications involving abrasive fluids, corrosive fluids and in applications requiring high temperatures and pressures. For example, seats with plastic, polymeric or elastomeric sealing elements are unable to withstand temperatures in excess of 250° C.

What is required is a ball valve seat with improved resistance to abrasion, increased durability and resilience, as well as superior seal performance.

### SUMMARY

In one embodiment, the present invention is a seat for a ball valve, the seat defining an axial bore along an inside surface of the seat. The seat inside surface is in contact with a fluid. At one end of the seat inside surface, the seat comprises a contact portion for contacting a ball. The contact portion comprises a metal-to-metal sealing surface, a thermoplastic seal and an elastomeric seal. The metal-to-metal sealing surface is disposed proximally to the inside surface, the elastomeric seal is disposed distally to the inside surface, and the thermoplastic seal is disposed therebetween, wherein the metal-to-metal sealing surface seals against the ball valve to seal fluid away from the thermoplastic and elastomeric seals.

In another embodiment, the present invention is a seat for a ball valve, the seat defining an axial bore along an inside surface of the seat. The seat inside surface is in contact with a fluid. At one end of the seat inside surface, the seat comprises a contact portion for contacting a ball. The contact portion defines at least one annular opening. The seat contact portion further comprises a metal-to-metal sealing surface, a thermoplastic seal contained within the at least one annular opening, and an elastomeric seal contained within the at least one annular opening. The metal-to-metal sealing surface is disposed proximally to the inside surface, the elastomeric seal is disposed distally to the inside surface, and the thermoplastic seal is disposed therebetween, wherein the metal-to-metal sealing surface seals against the ball valve to seal fluid away from the thermoplastic and elastomeric seals.

### DRAWINGS

FIG. 1 is a ball valve of the prior art.

FIG. 2 is a perspective view of a seat for a ball valve.

FIG. 3 is a cross-section view through a ball valve and two seats.

FIG. 4 is an enlarged view of a cross-section through a seat shown in FIG. 3.

FIG. 5 is an enlarged view of a cross-section through an alternate embodiment shown in FIG. 3.

### DESCRIPTION

The present invention is a ball valve seat with enhanced durability, resilience and seal performance. The present invention also provides a ball valve seat with a reduction in the amount of torque required to operate a ball valve.

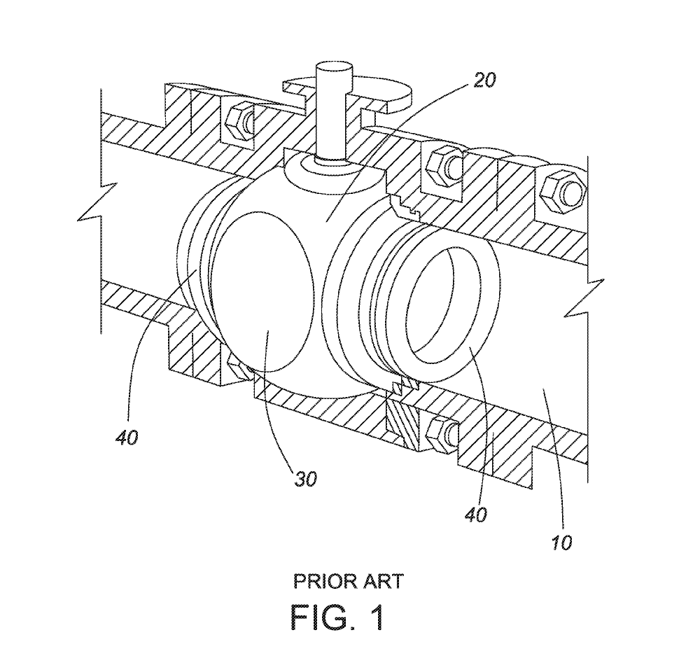

FIG. 1 shows a typical ball valve, inserted within a pipe (10). A ball (20) defining a bore (30), is positioned between two seats (40). Fluid flows through the bore (30) when the valve is turned into an open position. When the ball (20) is rotated to a closed position, the seats (40) cover the bore (30), to prevent leakage of fluid.

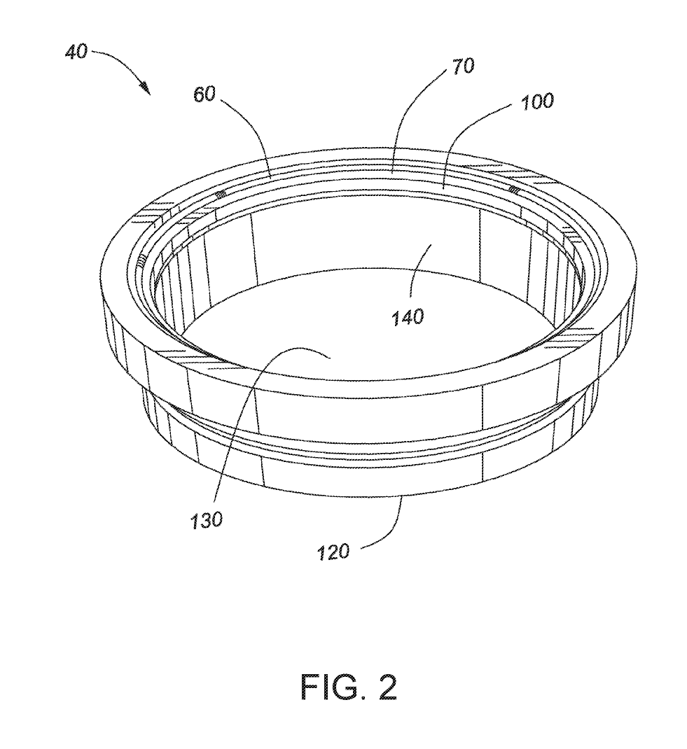

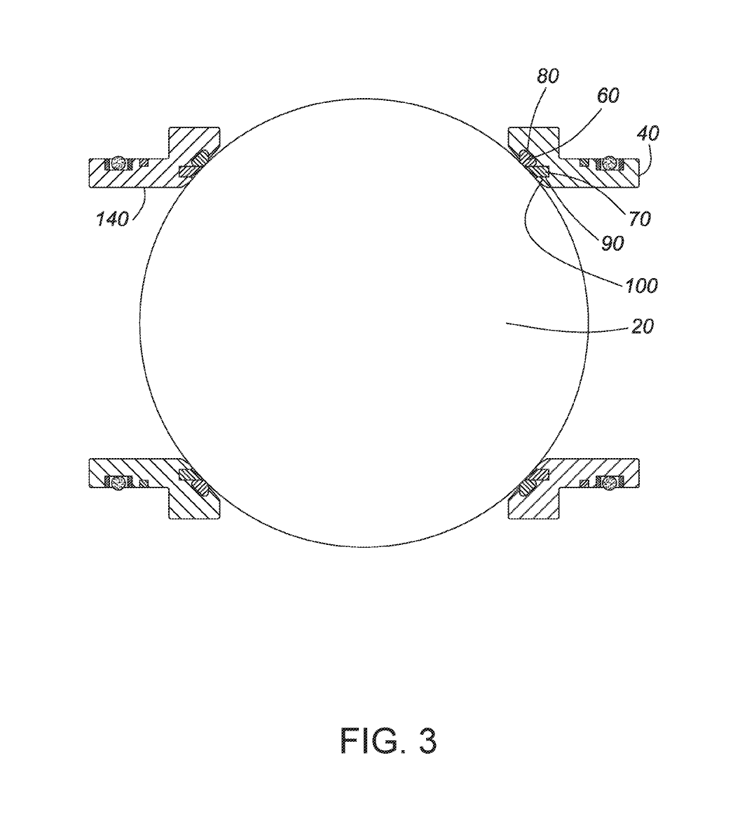

A seat (40) according to the present invention is shown in FIGS. 2 and 3. The seat (40) comprises two ends. A first end (120) is modified for attaching or inserting the ball valve (20) within a pipe (not shown). The seat also defines a seat bore (130), thereby providing a seat inner surface (140), which is in contact with the fluid moving through the pipe (not shown).

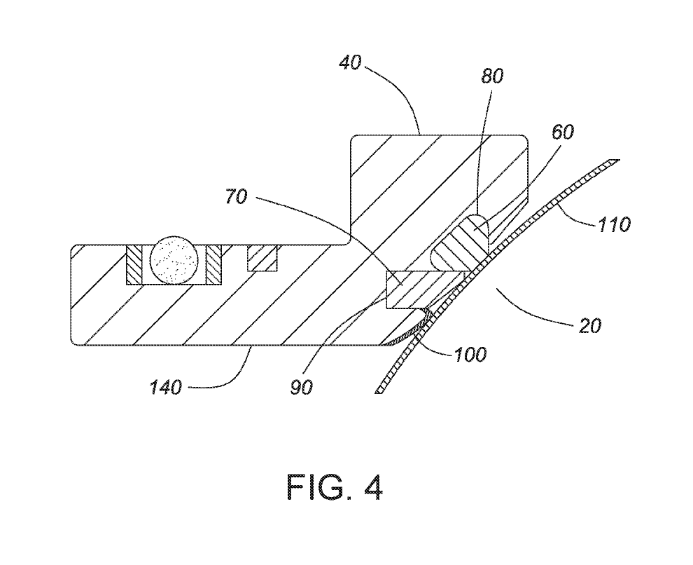

A second end, referred to herein as the contact portion (50) of the seat (40) is adapted for sealing the ball valve (20). As illustrated in FIG. 2, three annular sealing elements prevent leakage of a fluid past the ball (20), namely, an elastomeric seal (60), a thermoplastic seal (70) and a metal-to-metal sealing surface (100). In a preferred embodiment,using the seat inner surface (140) as a reference point, the order of the three annular seals is as follows: 1. metal-to-metal seal surface (100) 2. thermoplastic seal (70) 3. elastomeric seal (60) (see also FIG. 4). The metal-to-metal surface (100) is positioned near the seat inner surface (140) so that fluid entering the seat bore (130) would first contact the seal formed between the metal-to-metal sealing surface (100) of the seat and the ball (20). Any leakage would contact the thermoplastic seal (70), followed by the elastomeric seal (60).

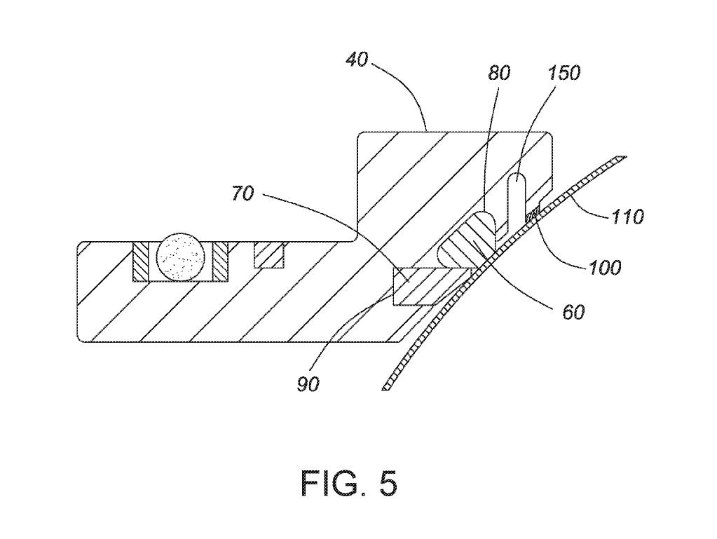

In an alternate embodiment shown in FIG. 5, the order of the three annular seals, again using the seat inner surface (140) as a reference point, is: 1. thermoplastic seal (70) 2. elastomeric seal (60) 3. metal-to-metal sealing surface (100). In this embodiment, fluid entering the seat bore (130) would first contact the thermoplastic seal (70). Any leakage would contact the elastomeric seal (60) followed by the seal formed between the metal-to-metal sealing surface (100) and the ball (20). The annular gap (150) allows for the seat to flex under high pressure/high temperature conditions.

The three annular seals may be spaced apart from one another or they may be immediately adjacent to one another. Immediately adjacent means that one sealing element abuts the neighbouring sealing element(s).

In order to accommodate the elastomeric seal (60) and thermoplastic seal (70), the seat contact surface (50) defines at least one annular opening (80, 90); (as seen in cross-section in FIGS. 3 and 4), which acts as housing for each of the elastomeric seal (60) and thermoplastic seal (70). The elastomeric seal (60) and opening (80) are immediately adjacent the thermoplastic seal (70) and opening (90).

As shown in FIGS. 3, 4 and 5, the elastomeric seal is in the form of a truncated delta ring seal as disclosed by applicant previously. The delta ring seal (60) is substantially triangular (ie as in delta from the Greek alphabet) with a truncated apex when viewed in cross-section (see FIGS. 3, 4 and 5). The truncated delta ring seal has previously been shown to resist extrusion and damage. The prior art also shows that placing a delta ring seal (60) immediately adjacent to (and abutting against) the thermoplastic seal (70), improves the seal (60) retention strength, thereby decreasing the likelihood of delta ring seal (60) extrusion.

Examples of thermoplastic materials available for thermoplastic seals include resins such as Nylon 6, Nylon 6+MoS2, Nylon+Fiberglass, Nylon 12 Devlon, PEEK-V, PEEK-S, PEEK-E, PEEK+PTFE, PEEK+Graphite, Virgin PTFE, PTFE Carbon filled/mod, PCTFE and Meldin. Examples of elastomeric materials suitable for elastomeric seals include Viton AED, Viton B, Viton GLT AED, Viton+PTFE Coating, HNBR AED, Aflas, Polyurethane and EPDM.

The seat metal-to-metal sealing surface (100) is manufactured according to methods known in the art. To prevent scoring or scratching of the metal surfaces of the seat and ball, it is known to apply a metallic coating, such as one of tungsten carbide, Caboflam™ H834 and chromium carbide, to both the ball (110) and the seat (identified as the metal-to-metal sealing surface herein, 100). Once the coating is applied, the coated surfaces are polished using a diamond chip grinder. Once coated and polished, a lapping process is used to ensure the metal-to-metal seal between the ball seat and the ball is leak tight.

In the preferred embodiment shown in FIG. 2 and FIG. 4, when a ball (20) is rotated to a closed position, fluid will first encounter the metal-to-metal seal formed between the seat metal-to-metal sealing surface (100) and the ball (20), then the thermoplastic seal (70), followed by the elastomeric seal (60). The metal-to-metal seal is much better able to withstand debris and other particular matter that may be present within fluid and protects the thermoplastic and elastomeric sealing elements from damage. The thermoplastic seal (70) is better able to withstand debris and other particulate matter that may be present within fluid than the elastomeric seal (60). If any fluid leaks past the thermoplastic seal (70), the elastomeric seal (60) will prevent the fluid from leaking past the ball valve.

A surprising advantage of the present invention is the reduced torque required to open and close the valve. Actuators for opening and closing the valve must be built to satisfy certain regulatory safety standards. While metal-to-metal ball valve seat assemblies are known in the art, generally, the larger the surface in contact between the ball valve seats and the ball, the greater the amount of torque required for valve opening and shutoff. Unexpectedly, torque tests conducted on Applicant's ball valve seats incorporating the three annular sealing elements described herein indicated there was 20-30% lower torque required to open and close ball valves that contain the ball valve seats of the present invention as compared to prior art ball valve seats with only a metal-to-meal seal. This means a savings in terms of the cost to manufacture the actuator required for valve opening and shutoff.

The present invention is particularly useful for high temperature/high pressure applications and for highly abrasive materials. One specific application is for natural gas pipelines where there are long distances between valves, which are buried underground and therefore not easily accessible in an emergency. In order to prevent loss of natural gas, as well as for safety and environmental considerations, valve assemblies must be robust, durable and capable of providing a leak-proof seal. The invention described herein provides resistance to abrasion as well as a reliable and resilient seal.

Furthermore, in order to maintain pipelines, “pigs” are used to clean out the pipes, and to X-ray pipes to track and prevent corrosion in the pipes. As cleaning occurs, debris is trapped in the gaps of the valve assemblies, which damages the thermoplastic and elastomeric seals of prior art ball valve seats. The metal-to-metal seal of the ball valve seat described herein protects the thermoplastic and elastomeric sealing elements from the abrasion as a result of the debris within pipe fluids.

Applicant has provided a solution that unexpectedly lowers the torque required to operate the valve, and also has the advantage of improving the durability, resilience and performance of ball valve seats.

What is claimed is:

1. A seat for a ball valve, the seat defining an axial bore along an inside surface of the seat, the seat inside surface contacting a fluid, the seat comprising:
a contact portion for contacting a ball, the contact portion disposed at one end of the seat inside surface, the contact portion comprising:
a metal-to-metal sealing surface,
a thermoplastic seal, and
an elastomeric seal,
wherein the metal-to-metal sealing surface is disposed proximally to the seat inside surface, the elastomeric seal is disposed distally to the seat inside surface, and the thermoplastic seal is disposed therebetween, and wherein the metal-to-metal sealing surface seals against the ball valve to seal fluid away from the thermoplastic and elastomeric seals.

2. The seat of claim 1 wherein the thermoplastic seal is disposed on the seat contact portion proximally to the seat inner surface, the metal-to-metal sealing surface is disposed distally to the seat inner surface, and the elastomeric seal is disposed therebetween.

3. The seat of claim 1 wherein the elastomeric seal comprises a truncated delta ring seal wherein an apex of the delta seal is pointed radially inward toward the valve and a base of the delta seal is orientated radially away from the ball valve;
wherein the seal base is wider than the apex and the apex protrudes toward the valve; and
the seal apex is truncated to define a substantially flat apical surface for sealing against the ball valve.

4. The seat of claim 3 wherein the thermoplastic seal is disposed proximally to the seat inner surface, the metal-to-metal sealing surface is disposed distally to the seat inner surface, and the delta seal is disposed therebetween.

5. A seat for a ball valve, the seat defining an axial bore along an inside surface of the seat, the seat inside surface contacting a fluid, the seat comprising a contact portion for contacting a ball, the contact portion disposed at one end of the seat inside surface, the seat contact portion further defining at least one annular opening, wherein the seat contact portion further comprises:
a metal-to-metal sealing surface,
a thermoplastic seal contained within the at least one annular opening, and
an elastomeric seal contained within the at least one annular opening,
wherein the metal-to-metal sealing surface is disposed proximally to the seat inside surface, the elastomeric seal is disposed distally to the seat inside surface, and the thermoplastic seal is disposed therebetween, and wherein the metal-to-metal sealing surface seals against the ball valve to seal fluid away from the thermoplastic and elastomeric seals.

6. The seat of claim 5 wherein the thermoplastic seal is disposed on the seat contact portion proximally to the seat inner surface, the metal-to-metal sealing surface is disposed distally to the seat inner surface, and the elastomeric seal is disposed therebetween.

7. The seat of claim 5, wherein the elastomeric seal comprises a truncated delta ring seal wherein an apex of the delta seal is pointed radially inward toward the valve and a base of the delta seal is orientated radially away from the ball valve;
wherein the delta seal base is wider than the apex and the apex protrudes beyond the opening and toward the valve; and
the delta seal apex is truncated to define a substantially flat apical surface while the delta seal still extends beyond the opening and toward the valve.

8. The seat of claim 7 wherein the thermoplastic seal is disposed proximally to the seat inner surface, the metal-to-metal sealing surface is disposed distally to the seat inner surface, and the delta seal is disposed therebetween.
